(19) United States
(12) Patent Application Publication
(10) Pub. No.: US 2005/0210397 A1
(43) Pub. Date: Sep. 22, 2005

(54) UI design evaluation method and system

(76) Inventors: Satoshi Kanai, Sapporo-shi (JP); Sou Horiuchi, Sapporo-shi (JP)

Correspondence Address: JOHN S. PRATT, ESQ;KILPATRICK STOCKTON, LLP, 1100 PEACHTREE STREET, ATLANTA, GA, 30309, US

(21) Appl. No.: 10/812,455

(22) Filed: Mar. 30, 2004

(30) Foreign Application Priority Data
Mar. 22, 2004 (JP) P2004-083286

(51) Int. Cl. G06F 3/00

(52) U.S. Cl. 715/762

(57) ABSTRACT

A system for evaluating user interface (UI) design is provided. On a mock-up (1) of the UI design, operation buttons (2) are arranged. An ID signal generating element (31) is embedded in each of the operation buttons. An ID signal reading element (11) is attached to a finger of a tester. The ID signal reading element is brought in contact with the ID signal generating element, to read an element ID signal from the ID signal generating element. The read element ID signal is converted into a button ID code according to a correspondence table (12) that shows correspondence between element ID signals to be generated by the ID signal generating elements and button ID codes assigned to the operation buttons in which the ID signal generating elements are embedded. According to the converted button ID code, an operation of UI software (21) is executed. A result of execution of the UI software operation is reflected in a screen image, which is projected as an image (3IM) onto a display corresponding part (3) of the mock-up in the same size as the display corresponding part. In this way, the system combines an actual model of a device housing prepared from the UI design with behaviors of UI software, to evaluate the usability of the device housing and UI software in an early development stage at low cost under conditions close to actual operating conditions.

### BACKGROUND OF THE INVENTION

1. Field of the Invention

The present invention relates to a user interface (UI) design evaluation method and a UI design evaluation system.

2. Background Art

Recent information technology (IT) devices involve advanced multiple functions, and there is an increased need for conducting usability evaluation on a user interface (UI) in the early stage of device development. The UI of an IT device consists of UI software and a housing. The UI software and housing are usually developed in parallel with each other, and mock-ups (test models) are prepared at several development stages by combining virtual model with physical model together and are evaluated for usability.

The usability evaluation is carried out from physical aspects and from cognitive aspects. Therefore, the usability of a UI is dependent on its housing design and software. To evaluate the usability of a UI, a functional mock-up of the UI is conventionally prepared. The functional mock-up consists of a housing provided with actually operable operation buttons and an actually displayable display, as well as a circuit board and UI software incorporated in the housing. The functional mock-up is subjected to a physical evaluation to judge the operability thereof and to see whether or not the fingers of the user interfere with the display. Also, a cognitive evaluation is carried out to examine functions of the UI software in response to button operations. Forming a mold and a die for the UI housing and producing the UI circuit board involves high expenses, therefore, the functional mock-up is usually prepared in the last stage of development of the device when a layout of parts such as the display of the device is substantially completed. There is a need, therefore, for conducting a usability evaluation on a UI by combining a housing and UI software behavior in an early stage of the designing of the UI.

### SUMMARY OF THE INVENTION

An object of the present invention is to provide a UI design evaluation method and system capable of combining an actual model of a UI with UI software and conducting a usability evaluation on the UI in an early stage of development of the UI under conditions close to actual use at low cost.

In order to accomplish the objective, a first aspect of the present invention provides a method of evaluating user interface (UI) design. The method includes receiving an element ID signal generated by an ID signal generating element and read by an ID signal reading element, the ID signal generating element being embedded in each operation button arranged on a mock-up of the UI design, the ID signal reading element being attached to a finger of a tester, the element ID signal being generated when the ID signal reading element is brought close to or in contact with the ID signal generating element; converting the received element ID signal into a button ID code according to a table prepared in advance, the table indicating correspondence between element ID signals to be generated by the ID signal generating elements and button ID codes assigned to the operation buttons in which the ID signal generating elements are embedded; issuing an instruction corresponding to the converted button ID code, to execute an operation of UI software to be activated by the operation button having the converted button ID code; acquiring a screen image representative of a result of execution of the UI software operation; and projecting the acquired screen image onto a display part of the mock-up in a size equivalent to the size of the display part.

According to the first aspect, a radio frequency ID (RFID) chip can be employed as the ID signal generating element and an RFID reader-writer can be employed as the ID signal reading element.

A second aspect of the present invention provides a system for evaluating user interface (UI) design. The system includes an ID signal generating element embedded in each operation button arranged on a mock-up of the UI design; an ID signal reading element having an attachment to be attached to a finger of a tester, configured to read an element ID signal generated by the ID signal generating element when the attachment is brought close to or in contact with the ID signal generating element; code conversion data configured to indicate correspondence between element ID signals to be generated by the ID signal generating elements and button ID codes assigned to the operation buttons in which the ID signal generating elements are embedded; a code converting unit configured to convert the element ID signal read by the ID signal reading element into a button ID code according to the code conversion data; a UI software execution instructing unit configured to issue an instruction corresponding to the converted button ID code and execute an operation of UI software to be activated by the operation button having the converted button ID code; a screen image acquisition unit configured to acquire a screen image representative of a result of execution of the UI software operation; and an image projection unit configured to project the acquired screen image onto a display part of the mock-up in a size equivalent to the size of the display part.

According to the second aspect, a radio frequency ID (RFID) chip can be employed as the ID signal generating element and an RFID reader-writer can be employed as the ID signal reading element.

According to the second aspect, the operation buttons may each have an adhesive material so that the operation buttons are freely attached to and detached from the mock-up.

Any one of the first and second aspects combines a housing model of a UI with behaviors of UI software to evaluate, at low cost, usability of the UI in an early stage of development under conditions close to actual use.

### BRIEF DESCRIPTION OF THE DRAWINGS

FIG. 1 is a general view showing a UI design evaluation system according to a first embodiment of the present invention;

FIG. 2 is a sectional view showing an operation button attached to a mock-up according to the first embodiment;

FIG. 3 is a view explaining a communication characteristic test carried out on an RFID reader-writer according to the first embodiment;

FIGS. 4A and 4B are graphs showing communication characteristics of the RFID reader-writer according to the first embodiment;

FIG. 5 is a photograph showing an attached state of an antenna of the RFID reader-writer according to the first embodiment;

FIG. 6 is a sectional view showing a sensitive range of an RFID chip according to the first embodiment;

FIG. 7 is a view explaining a design evaluation test carried out with the UI design evaluation system according to the first embodiment;

FIG. 8 is a flowchart showing the design evaluation test carried out with the UI design evaluation system according to the first embodiment;

FIG. 9 is an exploded perspective view showing a mock-up and a projector projecting an image onto the mock-up in a UI design evaluation system according to a second embodiment of the present invention;

FIG. 10 is a view showing a UI design evaluation system according to a third embodiment of the present invention;

FIG. 11 is a block diagram showing a visual wireless communicator (VWC) system according to an embodiment of the present invention;

FIG. 12 is a block diagram showing the steps of preparing a mock-up for the VWC system of FIG. 11;

FIG. 13 is a view explaining the steps of forming an operation button containing an RFID chip used for a UI design evaluation method achieved on the VWC system of FIG. 11;

FIG. 14 is a block diagram showing the steps of achieving the UI design evaluation method on the VWC system of FIG. 11;

FIG. 15 is a flowchart showing UI simulation software used for an operability test carried out on the VWC system of FIG. 11; and

FIG. 16 is a table showing a result of evaluation of button arrangements and operability of the VWC system of FIG. 11.

### DETAILED DESCRIPTION OF EMBODIMENTS

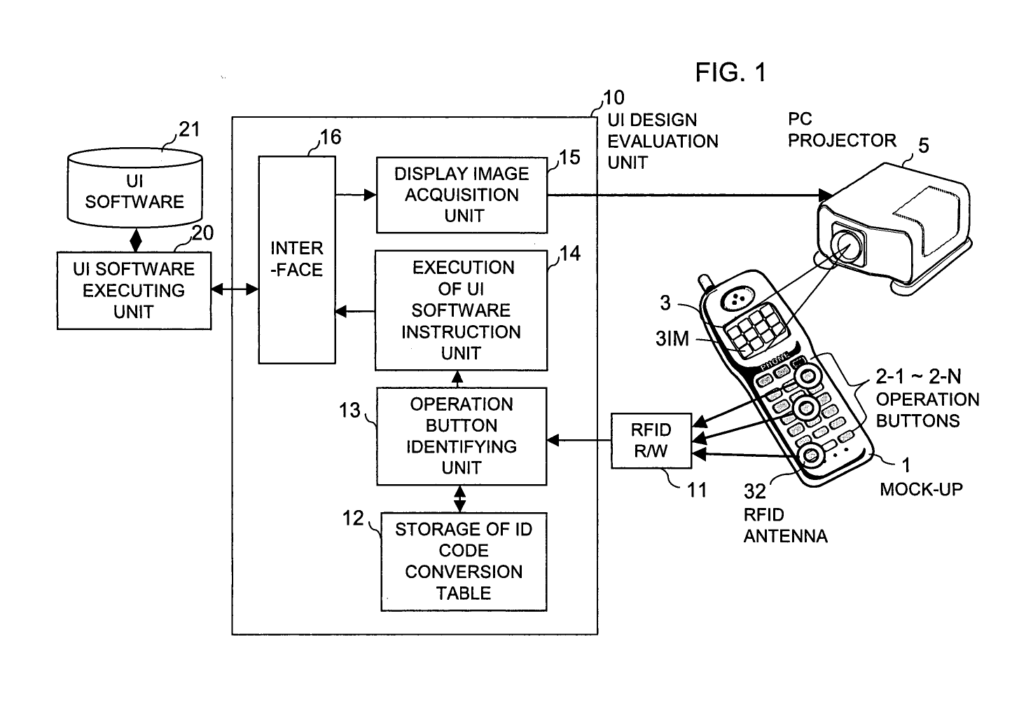

Embodiments of the present invention will be explained in detail with reference to the accompanying drawings. FIG. 1 is a view showing a UI design evaluation system according to the first embodiment of the present invention. A mock-up 1 is a housing of a device which is a design object. Operation buttons 2-1 to 2-N are detachably attached to the mock-up 1. The operation buttons 2-1 to 2-N are positioned at locations a designer has considered to be appropriate. An LCD installation location on the mock-up 1 is provided with a display corresponding part 3 having the same size as an LCD to be employed. A projector 5 is arranged at a position where the projector 5 can project an image having the same size as the LCD to be employed onto the display corresponding part 3 of the mock-up 1.

A UI design evaluation unit 10 includes various components. These components will be explained. A radio frequency ID (RFID) reader-writer 11 excites an RFID chip and reads a chip (or element) ID code from the RFID chip. Code conversion data storage 12 stores data indicating correspondence between chip ID codes of RFID chips embedded in the operation buttons 2-1 to 2-N and button ID codes of the operation buttons 2-1 to 2-N. For example, the data stored in the storage 12 indicates correspondence between a chip ID code of an RFID chip embedded in the operation button printed with “1” and a button ID code assigned to the “1” operation button, and correspondence between a chip ID code of an RFID chip embedded in the operation button printed with “ENTER” and a button ID code assigned to the “ENTER” operation button. An operation button identifying unit 13 converts a chip ID code provided by the RFID reader-writer 11 into a button ID code of the operation button in question according to the code conversion data stored in the storage 12. A UI software execution instructing unit 14 issues an instruction to execute an operation of UI software corresponding to the converted button ID code from the operation button identifying unit 13. A screen image acquisition unit 15 acquires a screen image representative of a result of execution of the UI software operation. An interface (I/F) 16 serves between the UI design evaluation unit 10 and a UI software executing unit 20.

The UI software executing unit 20 executes UI software 21, which is under development, according to an instruction provided through the interface 16. A result of execution of the UI software 21 is provided by the software executing unit 20 to the UI design evaluation unit 10 through the interface 16.

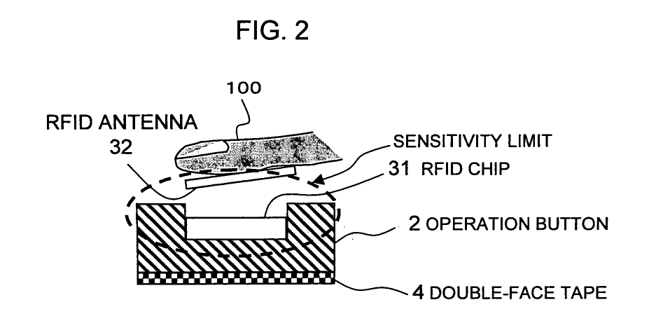

In FIG. 2, the operation buttons 2-1 to 2-N attached to an operation panel corresponding part of the mock-up 1 are formed separately from the mock-up 1 and are detachably attached to the mock-up 1, so that various shapes and arrangements of the operation buttons 2-1 to 2-N may be evaluated on the same housing design of the mock-up 1. Each operation button 2 (2-1 to 2-N) is provided with an RFID chip 31 (31-1 to 31-N) embedded in the surface of the operation button 2. The mock-up 1 has no input/output function, and therefore, it is necessary to realize a function of transferring a tester's button operation to the UI design evaluation unit 10 and a function of displaying an output of the UI software 21 on the display corresponding part 3 of the mock-up 1. The mock-up 1 must have no wires so that the operation buttons 2-1 to 2-N may be attached to and detached from the mock-up 1. To satisfy these conditions, the first embodiment employs the projector 5 to display an output of the UI software 21 and uses the RFID chips 31-1 to 31-N embedded in the operation buttons 2-1 to 2-N to transfer button operation signals. An antenna 32 of the RFID reader-writer 11 is brought close to the RFID chip 31, to read a chip (or element) ID code from the RFID chip 31. The read chip ID code is converted by the UI design evaluation unit 10 into a button ID code assigned to the operation button in which the RFID chip 31 is embedded, and according to the converted button ID code, a corresponding operation of the UI software 21 is executed.

An RFID system will be explained. The RFID system generally employs an RFID reader-writer to wirelessly write and read data to and from a small RFID chip (or tag). The RFID system has advantages that it can conduct noncontact communication with tags having no power sources, that it is very small, and that it can identify each tag according to an ID code transmitted from the tag.

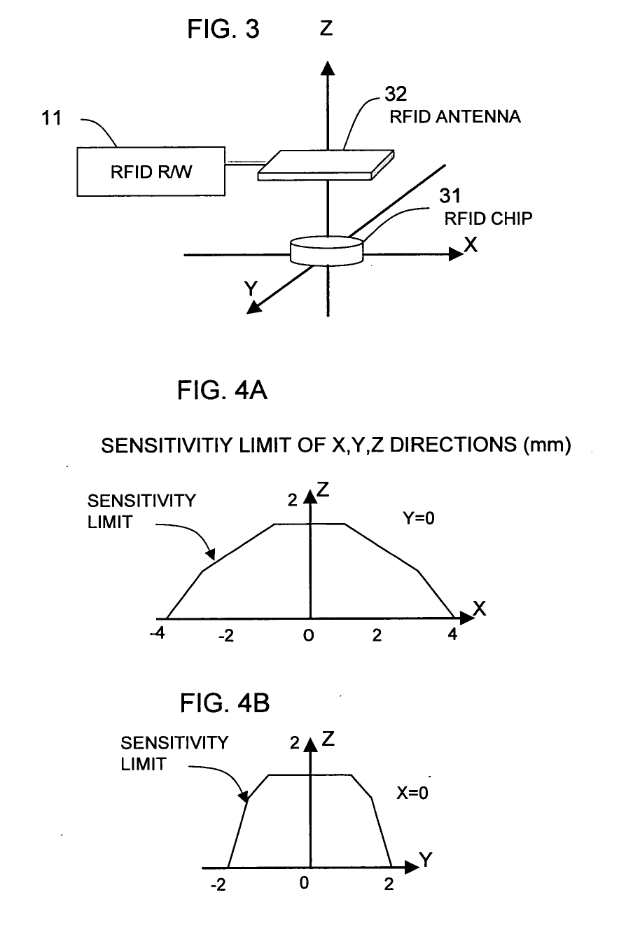

The present invention is not limited to employing a specific RFID system. The first embodiment employs, as an example, Coil-ON-Chip RFID system of Hitachi Maxell Company. The communication range of this RFID system will be explained. In FIG. 3, an RFID chip 31 of 2.5 mm square is fixed, and the antenna 32 of the RFID reader-writer 11 is moved at intervals of 0.5 mm in parallel with X, Y, and Z directions, to examine communication possibility. Measurement results are shown in the graphs of FIGS. 4A and 4B. According to the graphs, it is understood that a maximum communication distance in the Z direction is 2.0 mm. The reason why a plane of Y=0 and a plane of X=0 have different communication possible ranges is because the antenna 32 has a rectangular shape.

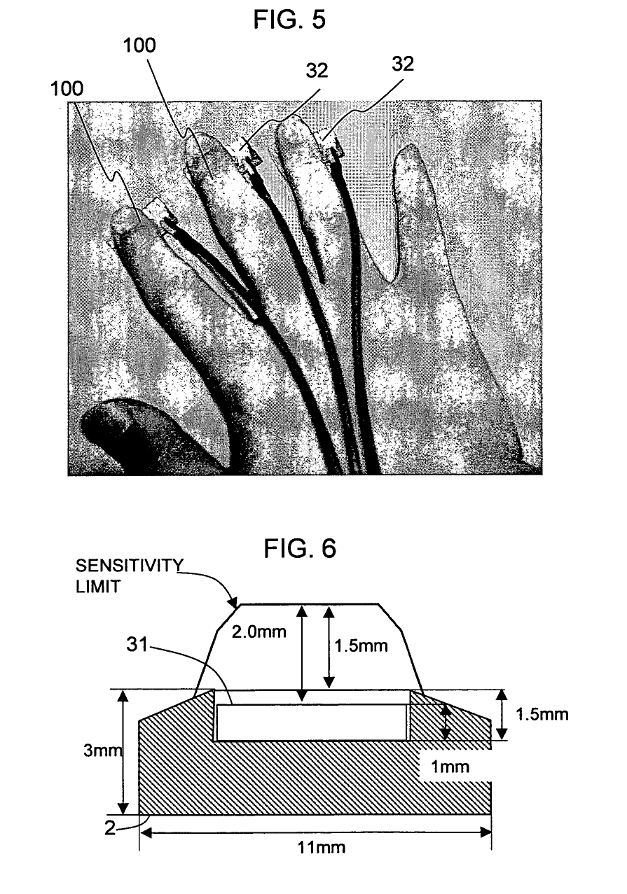

The first embodiment employs the RFID system having the above-mentioned communication characteristics. The RFID chips 31 are embedded in the operation buttons 2 as shown in FIG. 2, and single or plural antennas 32 of the RFID reader-writer 11 are attached to each of the lower surface of single or plural fingers 100 of a tester as shown in FIG. 5. Each antenna 32 can receive a signal, and according to the received signal, the RFID reader-writer 11 reads a chip ID code of the RFID chip 31 and transfers it to the UI design evaluation unit 10.

In FIG. 6, the RFID chip 31 has a thickness of 1.0 mm, and therefore, each operation button 2 is provided with a hole of 1.5 mm deep to receive the RFID chip 31. When the RFID antenna 32 is brought within a communication range of 1.5 mm from the surface of the operation button 2, it is recognizeed as an operation of pushing down the button. Namely, only when one of the RFID antennas 32 attached to each lower surface of the tester's fingers is brought close to the surface of the target operation button 2, the RFID antenna 32 senses the chip ID code of the RFID chip 31. There is, therefore, no risk of simultaneously sensing RFID chips in two or more operation buttons, and the RFID system can correctly identify the operation button 2 manipulated by the tester. The body of the RFID reader-writer 11 is attached to a wrist of the tester, and the RFID antennas 32 are attached to respective lower surface of the fingers of the tester, to realize an operation feeling close to an actual one. Each RFID antenna 32 may have a soft base which can softly fit to the lower surface of a tester's finger, to improve the operation feeling.

A UI design evaluation method employing the UI design evaluation system mentioned above will be explained. A mock-up 1 of a product housing in a design stage is prepared, and various operation buttons 2 are attached to an operation part of the mock-up 1. An RFID chip is embedded in each of the operation buttons 2 as shown in FIGS. 2 and 6. Each of the operation buttons 2 are provided with a double-face adhesive tape 4 and attached to a predetermined location on an operation side of the mock-up 1. Each operation button 2 is assigned with a button ID code that is used when executing the UI software 21. Each RFID chip embedded in the operation button 2 is assigned with a chip (or element) ID code. Correspondence between the button ID codes and the chip ID codes is stored in the storage 12. The UI software executing unit 20 is connected to the UI design evaluation unit 10 through the interface 16.

The UI design evaluation unit 10 is realized with a computer system. Accordingly, the UI software 21 to be evaluated and the UI software executing unit 20 may be installed in the same computer system. If a software designing department and an evaluation department are separated from each other, the UI design evaluation unit 10 may be connected to the UI software executing unit 20 through a network such as a LAN.

As shown in FIG. 5, single or plural antennas 32 of the RFID reader-writer 11 are attached to single or plural fingers 100 of the tester, respectively. An output of the RFID reader-writer 11 is connected through an interface such as USB or RS232C to a computer system serving as the UI design evaluation unit 10. The UI software 21 in a design stage is executed and is connected to the UI design evaluation unit 10 through the interface 16.

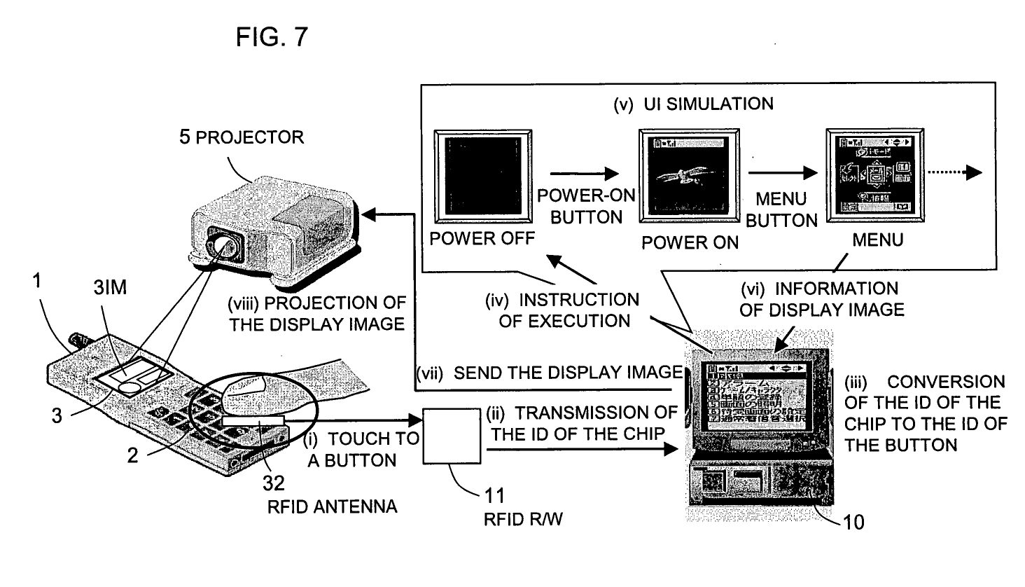

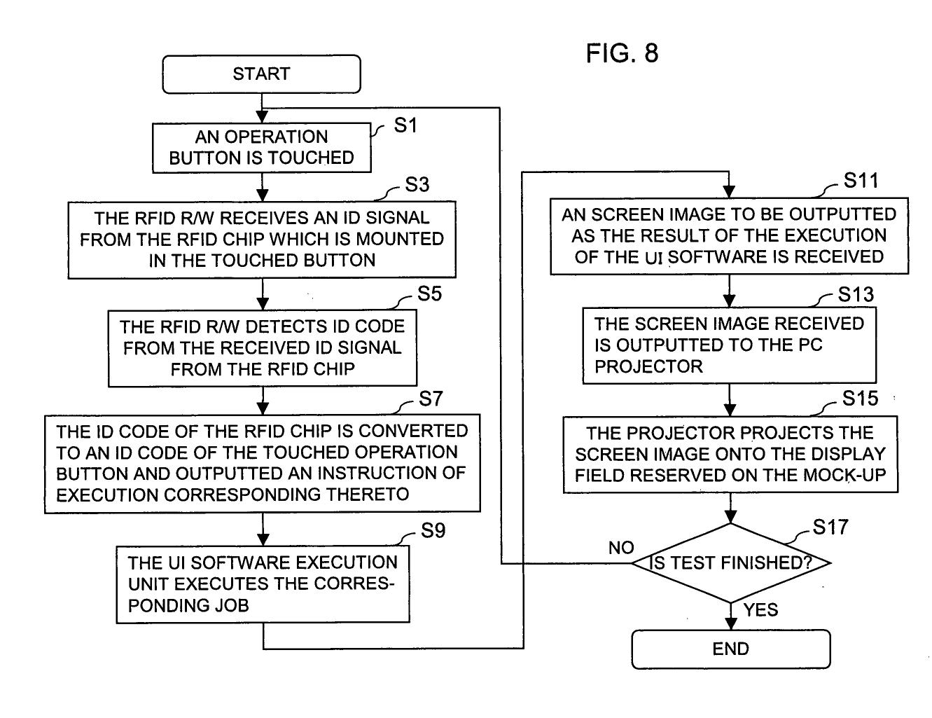

The tester manipulates the operation buttons 2 attached to the mock-up 1 to start evaluating the usability of the UI (step (i) of the sequence diagram of FIG. 7 and step S1 of the flowchart of FIG. 8).

The RFID antenna 32 attached to the finger 100 excites the RFID chip 31 in a target operation button 2 to make the RFID chip 31 transmit an ID signal, which is received by the RFID antenna 32 (step S3). The RFID antenna 32 transfers the received ID signal to the RFID reader-writer 11. The RFID reader-writer 11 specifies a chip ID code according to the transferred ID signal and sends the chip ID code to the operation button identifying unit 13 (step (ii) of FIG. 7 and step S5 of FIG. 8).

The operation button identifying unit 13 refers to the code conversion table stored in the storage 12, retrieves a button ID code corresponding to the received chip ID code, and transfers the button ID code to the UI software execution instructing unit 14 (step (iii) of FIG. 7 and step S7 of FIG. 8).

Upon receiving the button ID code, the UI software execution instructing unit 14 provides, through the interface 16, the UI software executing unit 20 with an instruction to execute an operation corresponding to the button ID code (step (iv) of FIG. 7 and step S9 of FIG. 8). In response to the instruction, the UI software executing unit 20 executes a corresponding operation of the UI software 21 (step (v) of FIG. 7). A result of execution of the UI software 21 is provided as a screen image, which is transmitted to the UI design evaluation unit 10 through the interface 16 (step (vi) of FIG. 7 and step S11 of FIG. 8).

The screen image acquisition unit 15 of the UI design evaluation unit 10 receives the screen image and transfers the image to the projector 5 (step (vii) of FIG. 7 and step S13 of FIG. 8). According to the transferred screen image, the projector 5 projects a screen image 31M onto the display corresponding part 3 of the mock-up 1 (step (viii) of FIG. 7 and step S15 of FIG. 8).

The tester observes the displayed image, confirms the operation of the UI software corresponding to the operated button, and evaluates whether or not the UI software 21 is proper.

In this way, the UI design evaluation system according to the first embodiment employs the mock-up 1 as having no actual circuits. When the tester manipulates any operation button 2 on the mock-up 1, the UI design evaluation unit 10 identifies the manipulated button, executes the UI software 21 accordingly, displays a result of the execution on the display corresponding part 3 of the mock-up 1, and allows the tester to visually inspect the operation result. In this way, the embodiment is capable of evaluating UI software, allows the tester to check an interference between the display corresponding part 3 and the operation buttons 2 during the evaluation, and enables the tester to check inconveniences in the design of the housing (mock-up 1).

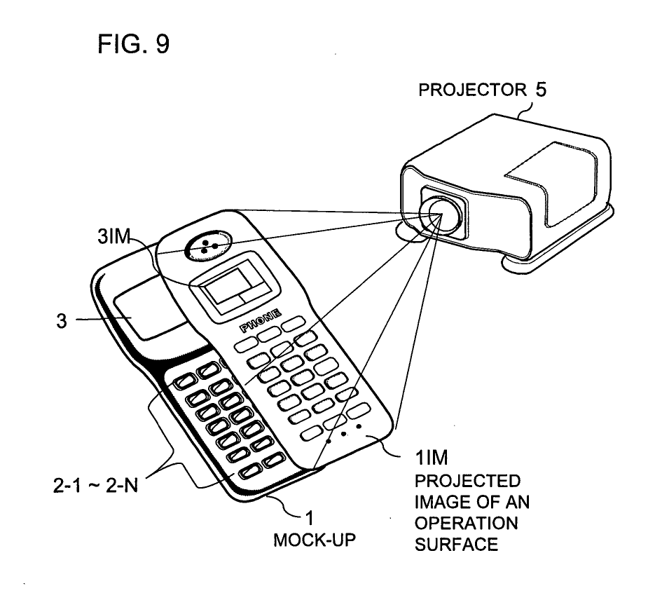

Next, a UI design evaluation system according to a second embodiment of the present invention will be explained with reference to FIG. 9. Unlike the first embodiment that simply projects, from the projector 5, a screen image on the LCD corresponding part 3 of the mock-up 1, the second embodiment of FIG. 9 projects, from a projector 5, a whole image 11M of an operation face of a mock-up 1, as well as a screen image 31M representative of an operation result overlaid onto a display corresponding part 3. Other functional structures of the second embodiment are the same as those of the first embodiment of FIG. 1.

Like the first embodiment, the UI design evaluation system of the second embodiment employs the mock-up 1 without actual circuits and operation buttons 2 attached to the mock-up 1. A tester manipulates any one of the operation buttons 2, and a UI design evaluation unit specifies the manipulated button, executes UI software accordingly, projects a whole image of the operation face of the mock-up 11M including an image representative of an operation result on the display 31M, and allows the tester to visually inspect the operation result. In this way, the second embodiment can evaluate UI software, allows the tester to check interference between the display corresponding part 3 and the operation buttons, and enables the tester to find inconveniences in the design of a housing (the mock-up 1) of the tested device.

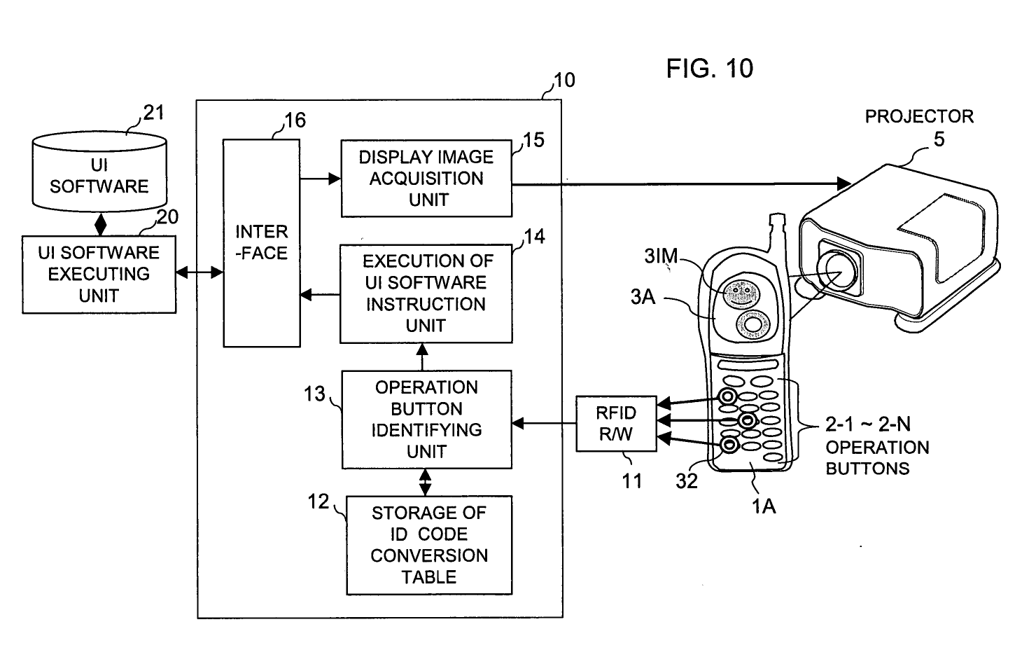

A UI design evaluation system according to a third embodiment of the present invention will be explained with reference to FIG. 10. Unlike the first embodiment that projects, from the projector 5, a screen image onto the display corresponding part 3 of the mock-up 1 from the front side of the mock-up 1, the third embodiment of FIG. 10 projects, from a projector 5, a screen image 31M onto a display corresponding part 3A of a mock-up 1A from behind the mock-up 1A. According to the third embodiment, the mock-up 1A is a half structure representative of an operation side of a product and is made of transparent resin. Alternatively, the display corresponding part 3A of the mock-up 1A according to the third embodiment may be made of transparent resin and may be thinned to cut off the back thereof. The projector 5 projects a screen image 31M to the back of the display corresponding part 3A. The image projected onto the back of the display corresponding part 3A must be seen as a normal image from the front side of the display corresponding part 3A. For this, the projector 5 projects a mirror image. Other components of the third embodiment are the same as those of the first embodiment shown in FIG. 1.

According to the third embodiment, a tester when manipulating operation buttons never blocks light from the projector 5 with his or her hands, and therefore, the tester can conveniently carry out evaluation.

According to the first to third embodiments, the RFID chip 31 is embedded in each operation button 2, and the antenna 32 of the RFID reader-writer 11 is fitted to the inner face of each finger of a tester. If the tester operates one of the operation buttons 2, the RFID reader-writer 11 reads a chip ID code from the RFID chip embedded in the operated button through the antenna 32. The read chip ID code is converted into a button ID code of the operated button according to a conversion table prepared in advance. An operation corresponding to the converted button ID code is simulated by UI software, and a result of the simulation is displayed. Instead of the RFID system, the present invention can employ any system that can correctly recognize a button ID code of an operation button when the button is accessed by or touched with a proper element. For example, conductive paint is applied to operation buttons to provide the operation buttons with different resistance values. In this case, correspondence between the electric resistance values and the operation buttons is registered in advance, and a microelectrode is attached to the lower surface of a finger of a tester. When the finger touches one of the operation buttons, an electric resistance value is measured, the touched button is identified according to the measured electric resistance and the correspondence data, and an operation of UI software corresponding to the identified operation button is executed.

Alternatively, a two-dimensional magnetic bar code is set on the surface of each operation button, and a bar code reader is attached to a finger of a tester. In this case, a manipulated operation button is identified according to the two-dimensional bar code set on the manipulated button, and an operation of UI software corresponding to the identified operation button is executed.

Instead, characters may be written on the surface of each operation button, and a small CCD to read the characters is attached to a finger of a tester. In this case, characters on a manipulated operation button is read by the CCD, an image of the read characters is analyzed to identify the manipulated button, and an operation of UI software corresponding to the identified button is carried out.

A technique that increases the degree of freedom of image projection from a projector onto a display part of a mock-up and avoids shadows made by hands will be explained. This technique hangs the mock-up with strings and winds the strings around pulleys each provided with a rotational angle sensor. A projected image from a projector is guided through mirrors to the display part of the mock-up. According to rotation angles measured on the pulleys, an attitude of the mock-up is detected. According to the measured attitude, angles of the mirrors are automatically adjusted so that an image from the projector is always correctly projected onto the display part of the mock-up. This technique allows a tester to hold the mock-up in his or her hand, freely manipulate the mock-up, and observe the display part of the mock-up.

### EXAMPLE

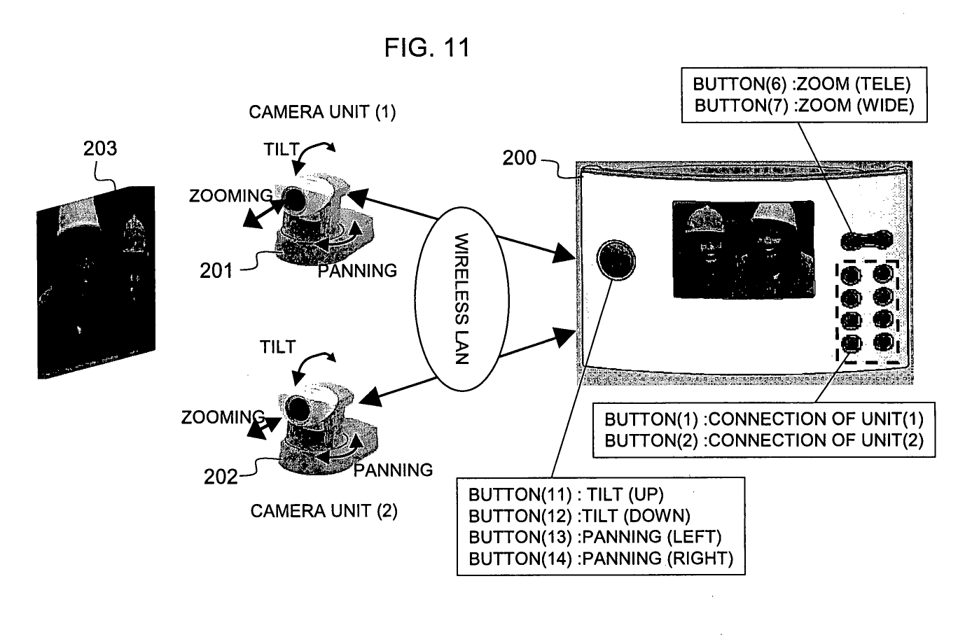

FIG. 11 shows an example of a UI design evaluation system according to the present invention. This example is a visual wireless communicator (VWC) system employing a wireless LAN to realize bidirectional communication among a plurality of points separated from one another by short distances. For this system, mock-ups are prepared to determine optimum locations of operation buttons (1) to (14). The VWC system includes cameras 201 and 202 connected to each other through a wireless LAN. Tilting (vertical), panning (horizontal), and zooming operations are carried out on the cameras 201 and 202 by remote control with the use of the operation buttons, to photograph an object 203 and display the photographed images on a display part of a main body 200. UI simulation software is configured to select and connect a camera unit (1) when the push button (1) is pushed and a camera unit (2) when the push button (2) is pushed. Seesaw buttons (6) and (7) are used for telescopic zooming and wide-angle zooming operations for the connected camera unit. Among the buttons arranged on a cross pad, the button (11) is used to carry out an upward tilting operation, the button (12) a downward tilting operation, the button (13) a left panning operation, and the button (14) a right panning operation for the connected camera unit. These buttons realize remote control functions.

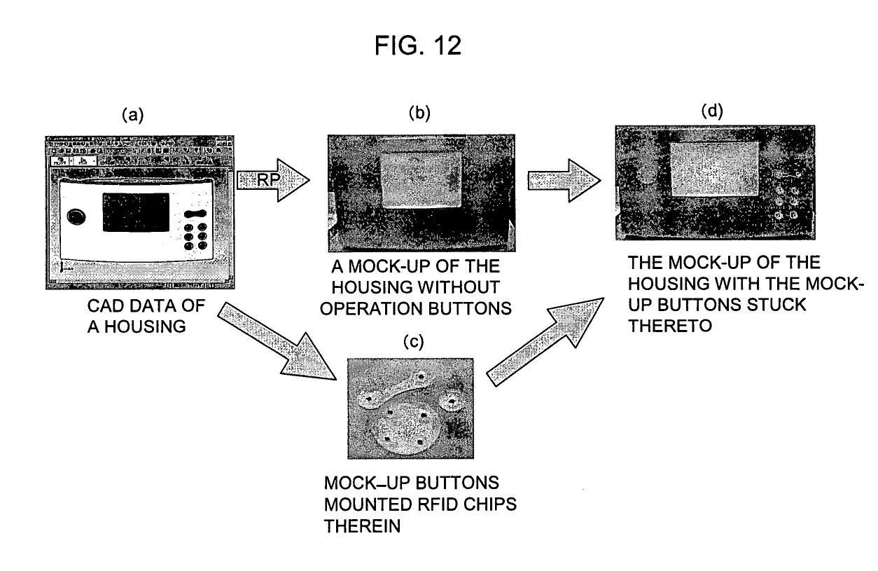

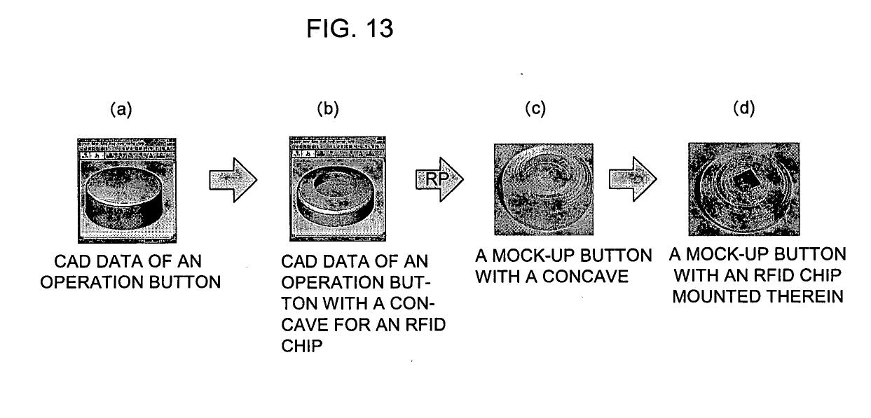

A housing mock-up of the VWC system is prepared according to sequences shown in FIGS. 12 and 13. In step (a) of FIG. 12, a VWC housing is designed by CAD. In step (b), a housing mock-up without operation buttons is made by laser lithography. The operation buttons are attached to the housing mock-up later. In step (c), the operation buttons (including push buttons, seesaw buttons, and cross buttons) are made. These buttons are attached to optional locations on the housing mock-up. FIG. 13 shows the details of making operation buttons. In step (a) of FIG. 13, each operation button is designed by CAD. In step (b), a hole to embed an RFID chip is designed by CAD on the operation button.

In step (c), the button with the hole is made by laser lithography according to the CAD data. In step (d), an RFID chip is embedded in the hole of the button. On the back of each button, a double-face adhesive tape is attached.

In step (d) of FIG. 12, the buttons with the embedded RFID chips are attached to the housing mock-up at given locations.

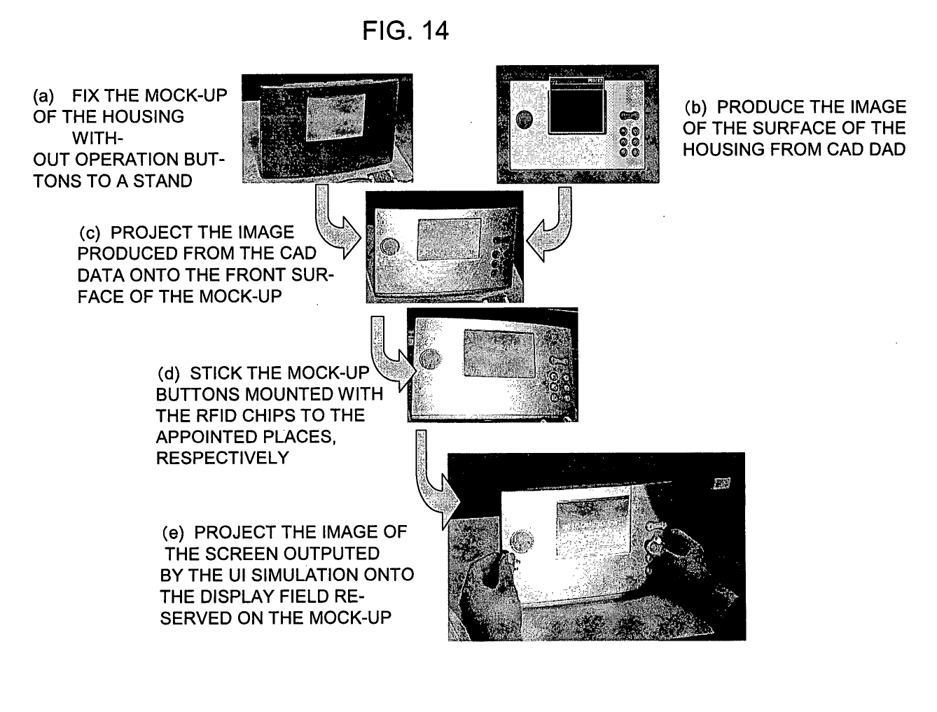

An operability evaluation method carried out on the VWC system mentioned above according to an embodiment of the present invention will be explained. In step (a) of FIG. 14, a housing mock-up without operation buttons is made according to the above-mentioned steps. In step (b), an image of an operation face of the housing is prepared by CAD. In step (c), the operation face image is projected from a projector onto an operation face of the housing mock-up. In step (d), operation buttons with embedded RFID chips prepared as mentioned above are attached to the locations of projected button images. In step (e), the operation buttons are actually operated to execute UI simulation software. An image representative of a result of the operation is projected onto a display corresponding part of the mock-up.

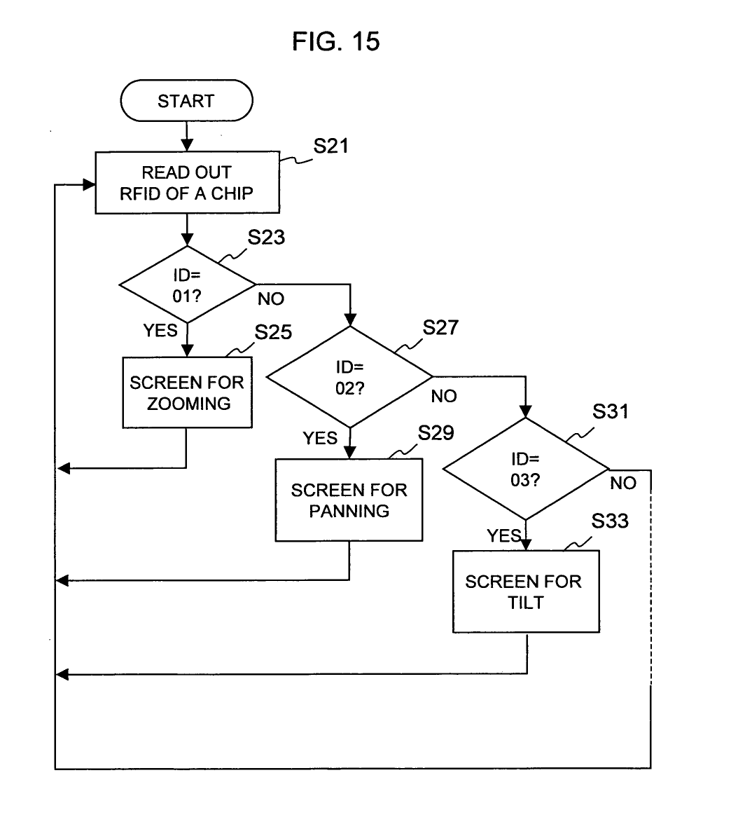

FIG. 15 is a flowchart showing operation of the UI simulation software. If one of the operation buttons shown in FIG. 14 is operated, a chip ID code is read from the RFID embedded in the button (step S21). If the chip ID code is “01,” a screen for zooming is displayed (steps S23 and S25). If the chip ID code read in step S21 is “02,” a screen for panning is displayed (steps S27 and S29). If the chip ID code read in step S21 is “03,” a screen for tilting is displayed (steps S31 and S33).

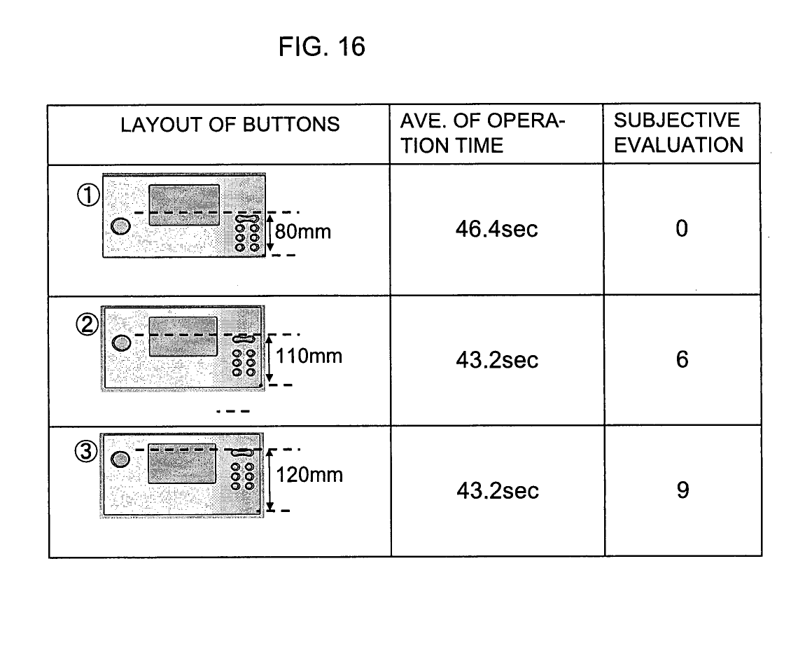

FIG. 16 shows a result of evaluation carried out by five testers. Each tester repeated the above-mentioned simple simulation operation on three different button arrangements 1 to 3 shown in a button layout column of FIG. 16. During the evaluation, operation speeds of the testers were measured. Each tester ranked the button arrangements 1 to 3 from the first to the third and gave the first ranked button arrangement two points, the second one point, and the third zero points. The points given by the five testers were totaled.

In connection with the ranks by the testers' operation speeds, the button arrangements 2 and 3 were substantially equal to each other and were superior to the button arrangement 1. In connection with the ranks by the points, the button arrangement 3 was the best, the button arrangement 2 the second, and the button arrangement 1 the third. As a result, the evaluation, which was carried out in a mock-up stage of an objective device with the use of UI simulation software, concluded that the button arrangement 3 was the best.

In this way, the present invention is capable of conducting a button arrangement operability evaluation with the use of a design mock-up which is a combination of a virtual image and an actual body.

1. A method of evaluating user interface (UI) design, comprising:
receiving an element ID signal generated by an ID signal generating element and read by an ID signal reading element, the ID signal generating element being embedded in each operation button arranged on a mock-up of the UI design, the ID signal reading element being attached to a finger of a tester, the element ID signal being generated when the ID signal reading element is brought close to or in contact with the ID signal generating element;
converting the received element ID signal into a button ID code according to a table prepared in advance, the table indicating correspondence between element ID signals to be generated by the ID signal generating elements and button ID codes assigned to the operation buttons in which the ID signal generating elements are embedded;
issuing an instruction corresponding to the converted button ID code, to execute an operation of UI software to be activated by the operation button having the converted button ID code;
acquiring a screen image representative of a result of execution of the UI software operation; and
projecting the acquired screen image onto a display part of the mock-up in a size equivalent to the size of the display part.

2. The method of claim 1, wherein:
the ID signal generating element is a radio frequency ID (RFID) chip; and
the ID signal reading element is an RFID reader-writer.

3. A system for evaluating user interface (UI) design, comprising:
an ID signal generating element embedded in each operation button arranged on a mock-up of the UI design;
an ID signal reading element having an attachment to be attached to a finger of a tester, configured to read an element ID signal generated by the ID signal generating element when the attachment is brought close to or in contact with the ID signal generating element;
code conversion data configured to indicate correspondence between element ID signals to be generated by the ID signal generating elements and button ID codes assigned to the operation buttons in which the ID signal generating elements are embedded;
a code converting unit configured to convert the element ID signal read by the ID signal reading element into a button ID code according to the code conversion data;
a UI software execution instructing unit configured to issue an instruction corresponding to the converted button ID code and execute an operation of UI software to be activated by the operation button having the converted button ID code;
a screen image acquisition unit configured to acquire a screen image representative of a result of execution of the UI software operation; and
an image projection unit configured to project the acquired screen image onto a display part of the mock-up in a size equivalent to the size of the display part.

4. The system of claim 3, wherein:
the ID signal generating element is a radio frequency ID (RFID) chip; and
the ID signal reading element is an RFID reader-writer.

5. The system of any one of claims 3 and 4, wherein:
the operation buttons each have an adhesive material so that the operation buttons are freely attached to and detached from the mock-up.
